(19) United States
(12) Patent Application Publication
(10) Pub. No.: US 2019/0171620 A1
(43) Pub. Date: Jun. 6, 2019

(54) SYSTEM AND METHOD FOR DATA ACQUISITION, ABSORPTION AND CURATION VIA A SERVICE AND SYNDICATION PLATFORM

(71) Applicant: DeepBD. Inc., Fairfax, VA (US)

(72) Inventors: Patrick McCollum, Fairfax, VA (US); Doug McCollum, Fairfax, VA (US); Ted Doll, Fairfax, VA (US)

(73) Assignee: DeepBD. Inc.

(21) Appl. No.: 16/202,829

(22) Filed: Nov. 28, 2018

Related U.S. Application Data
(60) Provisional application No. 62/593,714, filed on Dec. 1, 2017.

(51) Int. Cl. G06F 16/176; G06F 17/27; G06F 17/28; G06F 16/901; G06F 16/13; G06F 21/62

(52) U.S. Cl. CPC G06F 16/176; G06F 17/2705; G06F 21/62; G06F 16/9024; G06F 16/137; G06F 17/2809

(57) ABSTRACT

A data processing method, system, and computer program product include acquiring data of customer-defined internal and external sources, absorbing data into standardized structures which can be homogenously processed; curating data through a configurable workflow of a plurality of ready-made modules including any of optical character recognition (OCR), Natural Language Processing (NLP), and Associative graph loading, and syndicating the resulting data products via turnkey client apps and widgets for data sharing, visualization and granular monetization in a single, cohesive, digital marketplace.

### BACKGROUND

The present invention relates generally to a data processing method, and more particularly, but not by way of limitation, to a method, a computer program product, and a system for a Service & Syndication Platform (“SSP”): a data acquisition, absorption and curation platform that subsequently enables analytics, visualization and manages the data rights necessary to support syndication (e.g., purchase, lease, subscription) of the resulting data/artifacts.

Conventionally, data processing techniques have been fragmented across disparate tools each with their own data standards, security approaches and with little to no regard to licensing of the source or derivative data products other than for the present invention. In addition, no conventional techniques comprehensively combine into one self-scaling and automatically-replicable platform the tools for acquisition, absorption and curation of data in a cohesive, standardized, auditable and configurable manner all the way through to monetization using turnkey publishing tools.

And finally, to date, no conventional processing platform offers an integrated approach to crowd-sourcing and alt-coin based funding a workforce to handle any curation tasks requiring human intervention.

Thus, there is a need in the art for what is lacking in the current state of the art—namely all of the above abilities collectively integrated and available under one solution space.

### SUMMARY

The inventors have identified a number of problems in the art that are kindred to the myriad of issues which befell the manufacturing supply-chain and were revolutionized by enterprise resource planning systems. The data supply chain (e.g., acquisition, absorption, curation, forensics and licensing) is very different from manufacturing and there is no equivalent product or platform to handle even those needs much less the additional technical improvements that revolutionize the art. In view of these problems within the art, the inventors have considered a new technical improvement, which at the highest level delivers cohesive data processing management (e.g., data, data services and data syndication), and then additionally, drilling into the invention, solves the multitude of challenges previously described.

In an exemplary embodiment, the present invention provides a computer-implemented data processing method, the method including acquiring data via a variety of customer-defined internal and external sources, absorbing data into standardized structures which are homogenously processed, curating data through a configurable workflow of ready-made modules, syndicating the resulting data products via turnkey client apps and widgets (for data sharing, visualization and granular monetization) all via a single, cohesive, digital marketplace.

One or more other exemplary embodiments include a computer program product and a system.

The above summary will be described in more detail below with reference to the drawings. The invention is capable of embodiments in addition to those described and of being practiced and carried out in various ways. It is thus to be understood that the invention is not limited in its application to the details of construction and to the arrangements of the components set forth in the following description or illustrated in the drawings. Also, it is to be understood that the phraseology and terminology employed herein, as well as the abstract, are for the purpose of description and should not be regarded as limiting.

As such, those skilled in the art will appreciate that the present invention may readily be utilized as a basis for the designing of other structures, methods and systems for carrying out the several purposes of the present invention. It is important, therefore, that the claims appended hereto be regarded as including such equivalent constructions insofar as they do not depart from the spirit and scope of the present invention.

### BRIEF DESCRIPTION OF DRAWINGS

Aspects of the invention will be better understood from the following detailed description of the exemplary embodiments of the invention with reference to the drawings, in which:

FIG. 1 exemplarily depicts exemplarily depicts a top-level overarching system (Service & Syndication Platform 1000000 or “SSP”;

FIG. 2 exemplarily depicts a sub-system view 1000001 of the SSP 1000000;

FIG. 3 exemplarily depicts a creation of an environment 1100001;

FIG. 4 exemplarily depicts an updating of the environment 1100001;

FIG. 5 exemplarily depicts a removal of an environment 1100002;

FIG. 6 exemplarily depicts the entire Management Studio subsystem 2000000;

FIG. 7 exemplarily depicts Platform Subscriber Environment Components 3000000;

FIG. 8 exemplarily depicts Core Platform Environment Components 4000000;

FIG. 9 exemplarily depicts sub-system components 5000000 of SSP 1000000;

FIG. 10 depicts a cloud-computing node 10 according to an embodiment of the present invention;

FIG. 11 depicts a cloud-computing environment 50 according to an embodiment of the present invention; and

FIG. 12 depicts abstraction model layers according to an embodiment of the present invention;

FIG. 13 exemplarily shows a high-level flow chart for a data processing method 100 according to an embodiment of the present invention;

FIG. 14 exemplarily depicts a Graphical User Interface (GUI) for an implementation of the present invention;

FIG. 15 exemplarily depicts a Graphical User Interface (GUI) for an implementation of the present invention;

FIGS. 16-20 exemplarily depicts a Graphical User Interface (GUI) for an interview-style interface which guides them through the steps of setting up a Task Flow according to an embodiment of the present invention; and

FIG. 21 exemplarily depicts a GUI for monitoring a list of Task Flows and their status.

### DETAILED DESCRIPTION

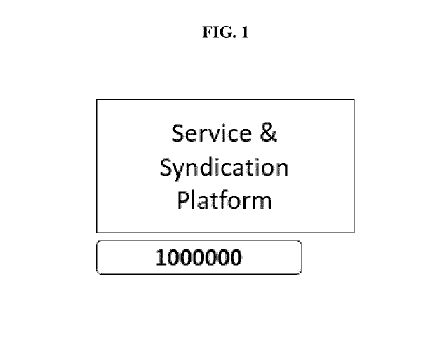

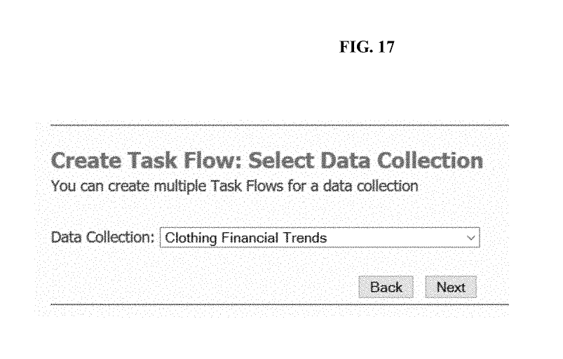

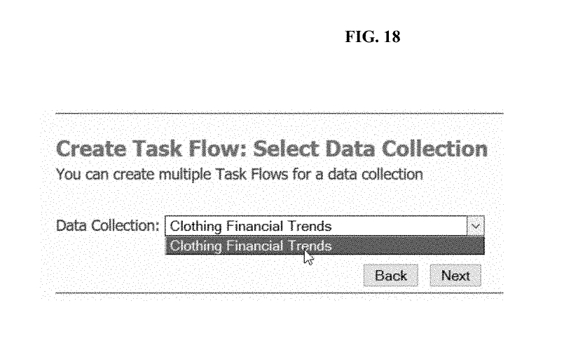

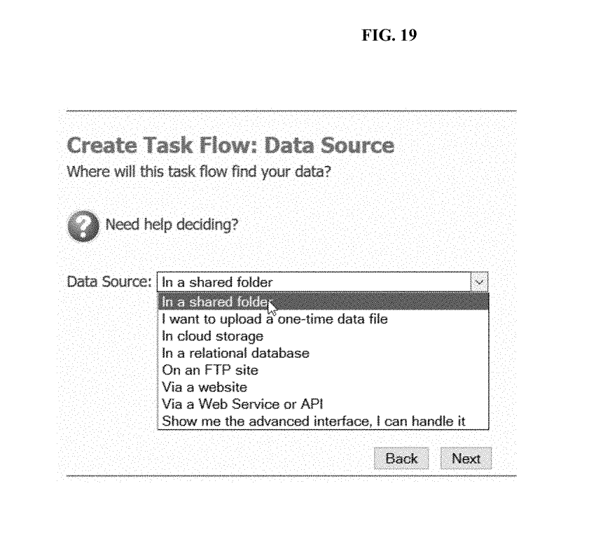

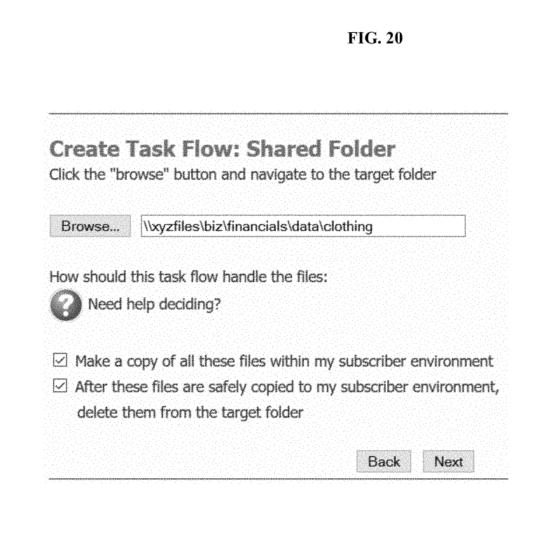

The invention will now be described with reference to FIGS. 1-21, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

With reference now generally to FIGS. 1-21, in one embodiment, the SSP may provide several capabilities to a platform administrators, Platform Subscribers, Customers and other entities. These SSP capabilities (referred to collectively as the “Services”) include but are not limited to data collection (“acquiring” and “absorbing”), data processing (“curation”), data aggregation, data analysis, data visualization, data subscriptions, data versioning, data chaining, data forensics, data publishing, data licensing, data syndication, notification services, and user interfaces relevant to these capabilities.

It is noted that ‘Core Platform Environment’ includes the data and software subsystems retained by the platform owner. Some or none of these subsystems may be made available to Platform Subscriber Environments depending on their subscription, but the Core Platform Environment (CPE) has additional capability for managing environments, data and data flow across the Core Platform Environment and all Subscriber Platform Environments.

It is noted that ‘Customer’, for the purposes of this specimen, customers can belong to either the platform owner or to Platform Subscribers. Platform Subscribers are also customers of the platform owner.

It is noted that ‘data collection’ herein includes Multiple Data Collection Items constitutes a Data Collection. Subscribers identify either Data Collection Items they would like to re-use which already exist within SSP, or they define new Data Collection Items, and use Jobs to collect and process the specific data. Either way, all the Data Collection Items for a specific Subscriber is considered that Subscriber's “Data Collection.”

It is noted that ‘data collection item’ includes a set of data, usually of a specific type (e.g. spending data, new articles, proposal documents, medical charts) and usually obtained from a specific source.

It is noted that ‘environment’ includes the platform owner Service and Syndication Platform works based on an interconnected set of environments. There is typically one Core Platform Environment (CPE), and many Platform Subscriber Environments (PSEs). Environments can contain multiple subnets, sometimes referred to as “sub-environments.”

It is noted that ‘platform subscriber’ used herein includes customers of the platform owner who are using the SSP to acquire, absorb and curate their own data/services to their customers and possibly to other Platform Subscribers.

It is noted that ‘Platform Subscriber Environment’ includes Platform Subscribers receive a subset of the Core Platform Environment based on their subscription options. Through this environment, Platform Subscribers can acquire, absorb and curate their own data, lease data from the platform owner and/or other Platform Subscribers, and make data available to their customers.

It is noted that ‘Services’ used herein is a term which collectively encapsulates the capabilities of the SSP, which include but are not limited to data collection (acquiring and absorbing), data processing (absorbing and curation), data aggregation, data analysis, data visualization, data subscriptions, data chaining, data forensics, data publishing, data licensing, data syndication, notification services, and user interfaces relevant to these capabilities.

It is noted that ‘Service & Syndication Platform’ includes a data acquisition, absorption and curation platform that subsequently enables analytics, visualization and manages the data rights necessary to support syndication (purchase, lease, subscription) of the resulting data/artifacts.

It is noted that a ‘Subscriber’ includes groups of customers (who might subscribe to either the platform owner or to a Platform Subscriber) and Platform Subscribers (who subscribe to the SSP and are customers of the platform owner). Both Customers and Platform Subscribers are grouped as a “Subscriber.”

### Tier 0: Service & Syndication Platform

The most aggregated form of this specimen is referred to as “Tier 0”, with subsystems and further componentry defined in subsequent tiers.

FIG. 1 exemplarily depicts a top-level overarching system (Service & Syndication Platform 1000000 or “SSP”). The SSP 1000000 is configured for the Platform owner and Platform Subscribers to utilize one-time or ongoing acquisitions and absorptions of data from a variety of sources (e.g., web/file content via a variety of protocols), which can then be curated and shared across the platform and down to direct customers of both the Platform owner and its Platform Subscribers.

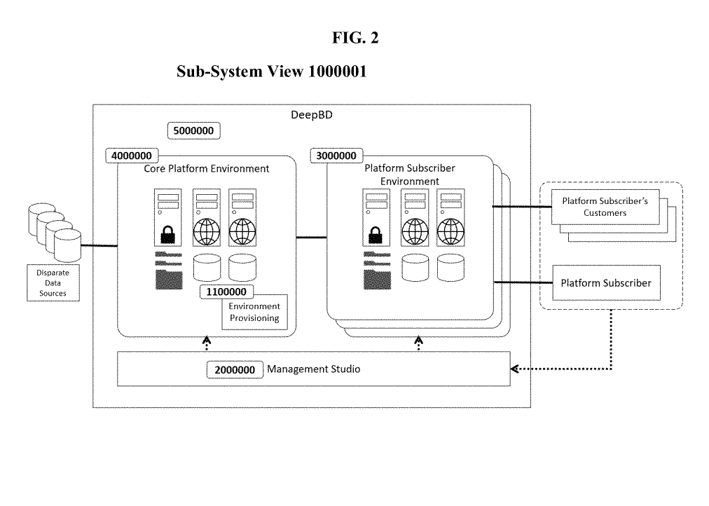

FIG. 2 exemplarily depicts a sub-system view 1000001 of the SSP 1000000. The sub-system view 1000001 includes the following sub-systems:

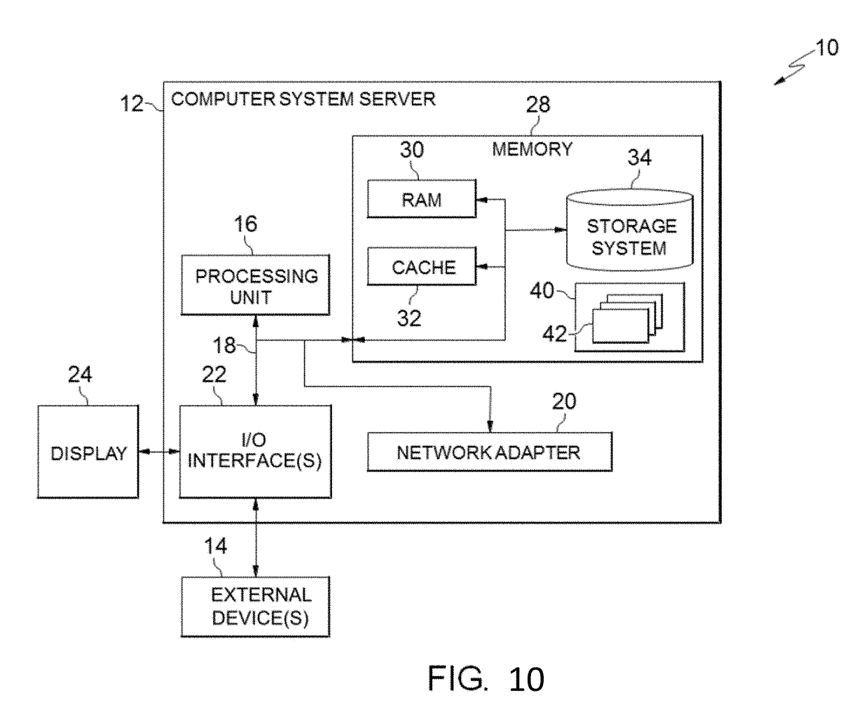

Environment Provisioning: The subsystem 1100000 configures environments, usually for Platform Subscribers, based on their subscription options, but this same subsystem can be used to create/modify one or more Core Platform Environments. The subsystem includes the following operations which can be executed by a processor in the subsystem based on instructions stored in a memory (e.g., as shown in FIGS. 10-13):

Management Studio (“DMS”): Platform Subscribers receive access to the Management Studio web interface to manage their environment via authorization by the DMS. In one embodiment, the subsystem 1000001 uses the Management Studio at a higher level of permissions and can manage the Core Platform Environment and resources across all Platform Subscriber Environments.

Platform Subscriber Environment (“PSE”): Platform Subscribers receive a subset of the Core Platform Environment based on their subscription options via the PSE. Through this environment, Platform Subscribers can acquire, absorb and curate their own data, lease data from the administrator and/or other Platform Subscribers, and make data available to their customers.

Core Platform Environment (“CPE”): These are the data and software subsystems retained by the platform owner. Some or none of these subsystems may be made available to Platform Subscriber Environments depending on their subscription, but the Core Platform

Environment has additional capability for managing environments, data and data flow across the Core Platform and all Subscriber Platforms.

Foundation Software Systems (“FSS”): This represents the various software designed and deployed for use across all the platform owner SSP subsystems and components.

### Tier 1: Environment Provisioning

Where Tier 0 is the top-level system, Tier 1 represents the subsystems outlined above at the next level of detail.

Environmental Provisioning handles creation of environments and tying them into maintenance and other subsystem/component resources needed for them to function in compliance with all the security and other requirements across the SSP. This subsystem is used to create/manage both the Core Platform Environment and Platform Subscriber Environment.

There are three figures at Tier 1 which essentially represent Environment Provisioning for creation, updates and removal respectively. Note: for each figure, it is not uncommon for subsequent steps to reach back to previous components to make further adjustments. For example, after Configure Storage, the process might need to reach back and tweak settings handled through Configure Security. This can happen during creation and/or during updates.

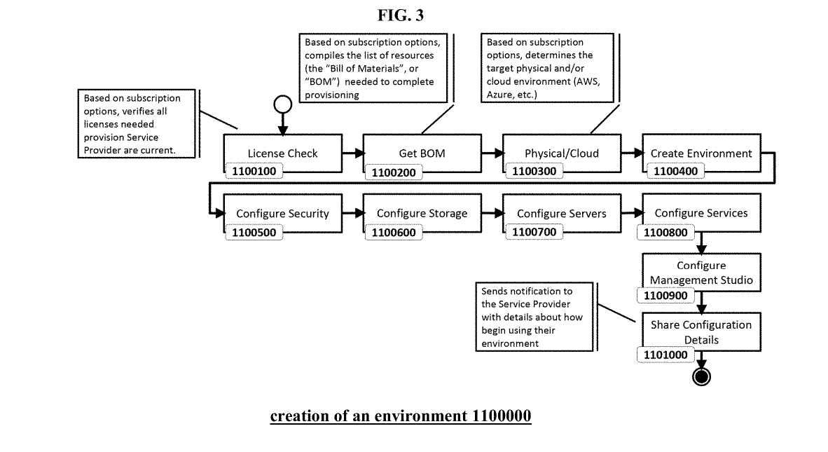

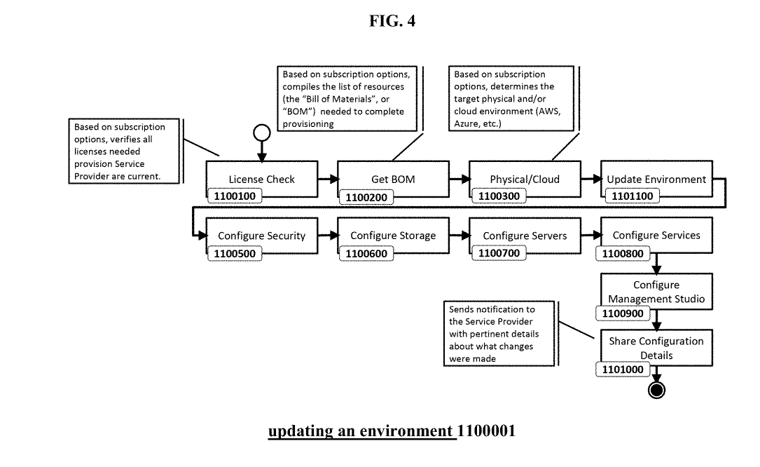

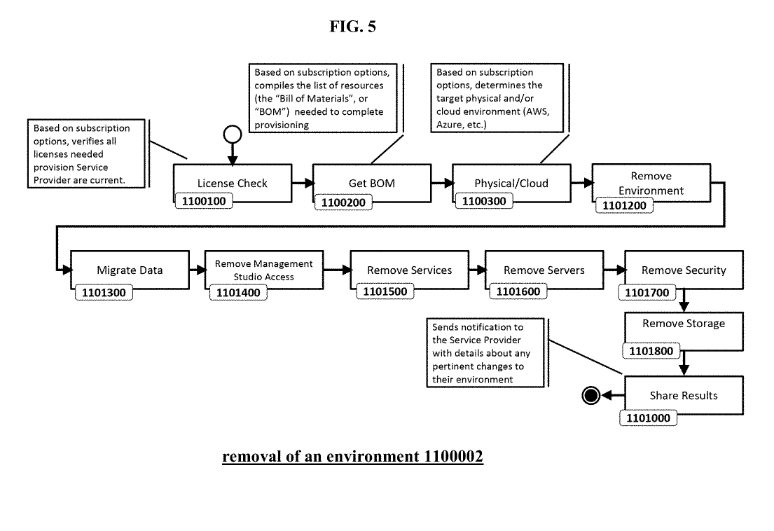

FIG. 3 exemplarily depicts a creation of an environment 1100001, and FIG. 4 exemplarily depicts an updating of the environment 1100001 like FIG. 3 except in FIG. 4, instead of component 1100400 (Create Environment), there is a component 1101100 (Update Environment) which engages similar processes in a slightly different manner. Moreover, FIG. 5 exemplarily depicts a removal of an environment 1100002. It is noted that FIG. 5 is different than FIGS. 3-4 because during the removal of an environment, many processes happen in reverse order, and in some cases, there will be data that is retained after the environment is removed, so another component 1101300 (Migrate Data) exists to cover this processing. All the components together make up the Environment Provisioning subsystem. The Environment Provisioning Subsystem includes:

License Check: When the platform owner personnel, contractors or Platform Subscribers attempt to access the Environment Provisioning subsystem, they are authenticated and authorized as needed, and part of the authorization process includes checking not only their permissions within the subsystem, but also their licensing to create, update and/or remove resources in their respective environments, be they CPE, PSE or both. In the case of platform automation, these security checks still happen, but there are system or service accounts which act on behalf of a human to automate the process.

Get BOM: The Bill of Materials (“BOM”) is created based on the licensing and is a list of all the environmental components that are both part of the target environment and are accessible by the user accessing the Environment Provisioning subsystem. In the case of automation, this access determination is applied to a service account.

Physical/Cloud: Whether an item in the BOM is based in a cloud or based on a physical appliance influences how environmental resources are controlled. Typically, all the resources are either all in the cloud or all managed via an appliance, but it is possible to have environments which span a mix of cloud(s) and physical deployment.

Create Environment: In the case the environment is being created, there are no existing resources, so this component is geared toward the additional step of provisioning new resources and registering them as part of the target environment. At this stage, the environment consists of infrastructure such as virtual private cloud(s)/network(s), subnet segmentation, DNS and base firewall settings.

Configure Security: Security is applied across a number of vectors; for example creation/maintenance of LDAP or equivalent domains, segmented roles, user accounts and service accounts, certificates and encryption, antivirus, network/packet monitoring, audit logging and if required, security can applied to match industry standard templates (e.g. low, moderate and high FedRAMP Authority to Operate).

Configure Storage: After the base infrastructure and security topography is in place, storage systems are created/updated per the applicable BOM and can include cloud storage, physical storage, volumes, Network Attached Storage, and includes any volumes intended for attachment to a virtualized server (if the server is not generated from a template which already specifies storage systems), and of course takes into account the cloud/physical requirements of the target storage resource.

Configure Servers: With network, security and storage created/changed, the next component operates at the server level. The platform works mostly with virtualized resources whether via a cloud or physical appliance, but it is possible to include physical servers in the BOM—they just cannot be created/removed.

Configure Services: This component adds/updates services to the target environment per the BOM. Services can be roles for the servers (docker, web app servers, API servers, database servers, OCR servers, NLP servers), other managed cloud services, resource management services (including services which handle load balancing, fail-over, replication and back-up/restoration) and integration to other services such as neural networks, graph systems, APIs, access to owned/leased/system data, publishing/subscriptions, turnkey clients and other 3rd party integrations.

Configure Management Studio: With the environment created/updated per the previously discussed processes, access to the environment is then created/updated so the appropriate users have the appropriate permissions monitor and control their environment, manager their leased/owned data collections, modify their subscription, access/configure any “turnkey” systems which allow Platform Subscribers, for example, to extend preconfigured applications/widgets to their own clients along with pricing, licensing and support.

Share Configuration Details: Once everything in the environment has been processed, the system will send details to all parties of interest (this can include administrators, Platform Subscriber administrators, and if different, the user who invoked the creation/updates to the environment) with any pertinent details, including how to start using new capabilities.

Update Environment: In the case the environment is being updated, there are existing resources, so the updates could be adding more resources, removing resources, updating security settings, applying patches, etc. The same components are invoked as during environment creation, and the same workflow is followed (with the same possibility that subsequent steps could invoke previously processed steps repeatedly as needed). This step therefore will be at the infrastructure level (e.g. VPC, network, subnet, DNS and firewall).

Remove Environment: In the case of removing an environment, the workflow steps are similar but generally done in reverse order (analogous to building/removing a pyramid, the former starts at the bottom works upward, the latter starts at the top and works downward). For that reason, other than the Migrate Data component, none of the “removal” components are described in additional detail.

Migrate Data: An environment may contain data which should be preserved after the environment is removed: it could be in support of restoring the environment later, there could be data made available to other subscribers on the SSP via a derived data chain which should continue to be available. For this reason, the data will be migrated to a location where it can be restored at a future date or where it can continue to be accessed as needed and as agreed per the terms of applicable data licensing in effect when an environment is to be removed.

Remove Management Studio Access: Like Configure Management Studio, only for removal of access to Management Studio.

Remove Services: Like Configure Services, only for removal of services.

Remove Servers: Like Configure Servers, only for removal of servers.

Remove Security: Like Configure Security, only for removal of security.

Remove Storage: Like Configure Storage, only for removal of storage.

### Tier 1: Management Studio

The Management Studio executes command and control over the entire SSP. Administrators and Platform Subscribers use this subsystem, via role-based authentication, to configure, maintain and monitor Services provided via the SSP.

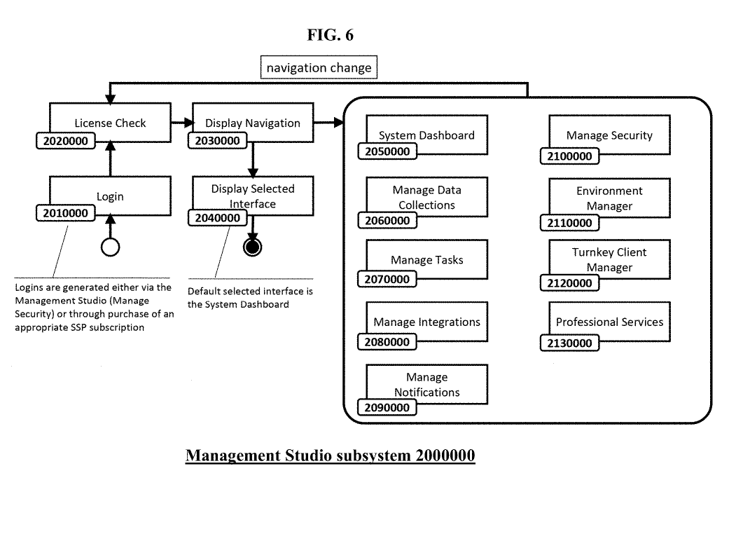

FIG. 6 exemplarily depicts the entire Management Studio subsystem 2000000. The Management Studio subsystem 2000000, which begins with a login, offers navigation and offers an ongoing license check as Subscriber navigates to various components within this subsystem:

Login: This process allows a Subscriber to authenticate and, if granted access, they will be authorized to use capabilities within the Management Studio commensurate with their assigned roles.

License Check: Upon logging in (and anytime they navigate to another component within the Management Studio), there is a licensing check which evaluates if their license is still active and evaluates their role against the selected component to determine what capabilities (e.g., permissions and privileges) are made available to the Subscriber. This is done every time navigation changes so that the system is always checking the most current license information (should their license be revoked, suspended, or their permissions otherwise impacted).

Display Navigation: Exact components made available to a Subscriber are determined by their role. Hence, the navigation options are evaluated when the Subscriber logs into the Management Studio, and every time they navigate to a different component (or a different view within a component).

Display Selected Interface: When a Subscriber first logs into (via the Login component) the Management Studio, they will be shown a default interface, which is set to the System Dashboard, as this component has the broadest permissions and every Subscriber should be able to access some information via this component. Depending on the Subscriber's permissions, they may or may not be able to navigate to other components of the Management Studio. If they can use other components, those navigation options will be available, and as they navigate to different components, this component will handle rendering the appropriate interface to the Subscriber.

System Dashboard: The System Dashboard is a configurable component that can generate real-time visualizations with drill-downs into the backing data, and can also be used for configuration and dissemination of various reports/alarms across the platform.

Manage Data Collections: The entire platform is driven by Data Collections. Each type of data (Data Collection Item) being collected is defined, cataloged and grouped within the Manage Data Collections component. The Manage Data Collections component can also be used to subscribe to data that is published by the platform owner or other Platform Subscribers, and can be used to publish data to other subscribers, or to map data to one of the Turnkey Client interfaces.

Manage Tasks: Once a Data Collection Item is defined, the user can set up tasks to acquire, absorb and/or curate the data (if the data is from a subscription, then it must be flagged to participate in derivative processing, and if allowed, the Data Chaining/Forensics manages derived data and its licensing). Jobs can interact to drive the Dashboard, Integrations, Notifications, and/or the Turnkey Client interfaces.

Manage Integrations: Integrations involve subscribing or publishing data to other data systems. Integrations to products such as CRM platforms, Content Management Systems, Social Media Platforms, 3^{rd} party API Aggregators and even custom API calls can be mapped via Jobs & Integrations.

Manage Notifications: As the Dashboard, Jobs and Integrations function, they may trigger various forms of notification (email, dashboard data, alarms, audit trails, SMS text, phone calls). These types of triggers, templates, and other rules for notifications, are defined within the Manage Notifications component.

Manager Security: Users with sufficient permissions can create and/or edit accounts at various levels within the Management Studio. These accounts can be other user accounts, or system accounts and the permissions configured are then translated into the equivalent NTFS, AD/LDAP and/or IAM permissions needed to support the requested functionality.

Security is also used to manage firewall, service end-points, and port numbers across the systems (at the Core Platform Environment or Platform Subscriber Environment level).

Environment Manager: This component allows a Subscriber to manage either CPE and/or SPE resources, allowing them to add, edit or suspend resources such as networks, storage, servers, and/or services. This includes load balancing, fail-over, back-up/recovery, and retention/archiving policies.

Turnkey Client Manager: The Management Studio can, via this component, provision one or more client interfaces, including e-commerce (and crypto/token commerce), standardized web applications, reusable widgets and templated content generators for notifications, syndication, SEO and other uses. The platform owner can use this capability to provision branded interfaces/widgets for use by other entities, and Platform Subscribers can use this capability to productize their data collections; their customers can search, generate pipelines, access dashboards, etc. all using various capabilities exposed via the Turnkey Client system.

Professional Services: Like the Turnkey Client Manager, Professional Services can be used both for Platform Subscribers to access support and to provide support to their downstream clients. Professional Services includes forum communities, knowledge bases, support ticketing options, video help system and live support (both chat and video), all based on the subscription of the Platform Subscriber and/or their customers. This can include everything from employees of the platform owner performing direct consulting, to 3rd party providers white-labeling services to a Service Provider's clients, all the way to crowd-sourced micro projects.

Tier 1: Platform Subscriber Environment

The Platform Subscriber Environment (PSE) is a wholly autonomous environment generated via the Environment Provisioning subsystem and managed by one instance of the Core Platform Environment (CPE). A separate PSE is generated for each Platform Subscriber organization/entity (which may include many users with varying levels of access to the PSE). As the PSE represents a subset of the Core Platform Environment (CPE), only those aspects of the PSE which vary from CPE are covered in this section. For more information, see below the subsequent section on the Core Platform Environment.

The PSE gives an organization a complete set of tools to acquire, absorb, curate, analyze, process, visualize and interact with both their processing systems and the resultant data curated and made actionable by the system. This also includes licensing/sub-licensing/leasing and other data agreements which enable subscribers to access and/or syndicate each other's data/derivatives under mutually agreeable terms. It is a complete platform which can also integrate with many other 3rd party platforms as needed by the Platform Subscriber.

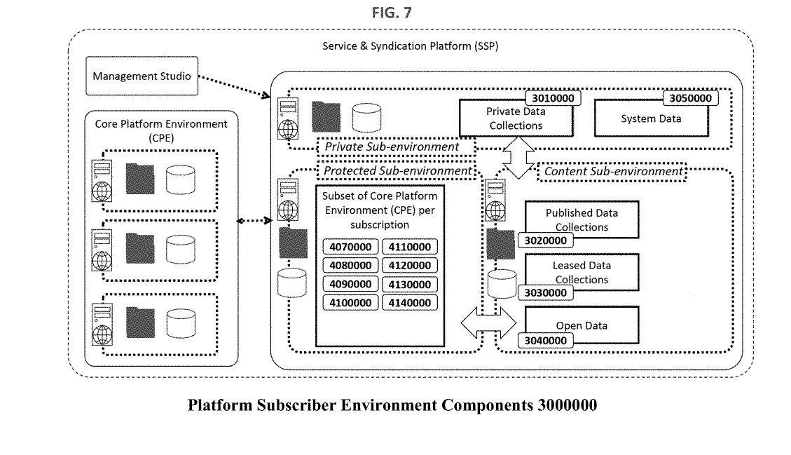

FIG. 7 exemplarily depicts Platform Subscriber Environment Components 3000000. The Platform Subscriber Environment Components 3000000 include

Private Data Collections: Unlike Private Data under the CPE, which is tied to the platform owner, these private data and associated systems are retained by the Platform Subscriber. The subscriber places resources here whenever they do not intend to make these resources available beyond the subscriber's own PSE. The platform owner retains the intellectual property used to acquire, absorb, curate, process, store and otherwise make the data and associated systems available, but the subscriber retains ownership of the source data and the resulting formats that data might take after it has been processed.

Published Data Collections: Unlike Leased Data under the CPE, which represents all the data published to which subscribers can easily subscribe, this published data represents the data and associated systems that are specific to a particular subscriber—either published data to which they are subscribed (“Inbound Published Data”), or data which they have agreed to publish (“Outbound Published Data”). The SSP ensures that subscribers can only use published data in accordance with the terms under which it is published.

Leased Data Collections: Unlike Leased Data under the CPE, which is concerned with all the data leasing activities in play, this item is specific to the Platform Subscriber's leased data: either data they are leasing (“Inbound Leased Data”) or data they are leasing to the platform owner, other Platform Subscribers and/or 3^{rd} Parties (“Outbound Leased Data”). As leased data arrangements can be more complex than published data, the SSP will endeavor to enforce the terms of a lease arrangement in so far as the platform will allow.

Open Data: Unlike Open Data under the CPE, which is concerned with Open Data obtained by the platform owner, this item is specific to Platform Subscriber's Open Data, which can be data they are consuming (“Inbound Open Data”) or data they are making available (“Outbound Open Data”). The SSP ensures that subscribers cannot make Outbound Open Data available if the source data is not also Open Data. The SSP ensures, in so far as it is able, that Inbound Open Data is indeed open data.

System Data: Like System Data under the CPE, however this data is generated by the subscriber and/or their clients. The platform owner does have rights to all System Data across the platform.

Tier 1: Core Platform Environment

The Core Platform Environment (CPE) is the command and control center of the entire SSP; however, there can be more than one instance of a CPE which commands more than one Platform Subscriber Environment (PSE). Note that each PSE can only be directly associated with one CPE, and each instance of the Management Studio is likewise only able to command and control one CPE and its associated PSEs.

The CPE is a wholly autonomous environment generated via the Environment Provisioning subsystem and managed via the Management Studio. The CPE can control as many PSEs as there are resources with which to do so. The CPE gives The platform owner a complete set of tools to acquire, absorb, curate, analyze, process, visualize and interact with both their processing systems and the resultant data curated and made actionable by the system. This also includes licensing/sub-licensing/leasing and other data agreements which enable subscribers to access and/or syndicate each other's data/derivatives under mutually agreeable terms. As the CPE is a more powerful and comprehensive environment than a PSE, it also allows the platform owner to extend a subset of capabilities from its CPE to PSEs, based on configurable subscription and data rights management. It is a complete platform which can also integrate with many other 3rd party platforms as needed by the platform owner and their Platform Subscribers.

The CPE includes data and software systems retained by the platform owner. Some or none of these systems may be made available to Platform Subscriber Environments depending on their subscription, but the Core Platform Environment has additional capability for managing environments, data and data flow across the Core Platform and all Subscriber Platforms.

The data within the CPE is protected at different levels depending on the purpose of the data and its availability to subscribers and/or the general public. The platform owner retains all right and title to the intellectual property used to acquire, absorb, curate, process, store and otherwise make the data and associated systems available, as well as the data itself, in all forms. The platform owner has sole discretion over if and how these data and/or systems are shared, leased, metered, sold, including the right to terminate any such arrangements at any time for any reason without notice or cause. There are further distinctions between these otherwise similarly named data components which influence the Platform Subscriber's use of the data, and one of the SSPs market differentiators is the ability to manage an all the data as it is processed, consumed, split, combined and otherwise utilized across the platform. This is accomplished through the use of data chaining and forensics and application of proprietary identifiers which in the most general sense build a trail of each record or item of data that is acquired and absorbed and through the use of the proprietary identifier assigned to each such item or record, is traced through its curation. The SSP can then identify the ultimate source of data and can determine which data, if any, may be claimed by a Platform Subscriber and which data/derivatives are part of the platform owner's intellectual property.

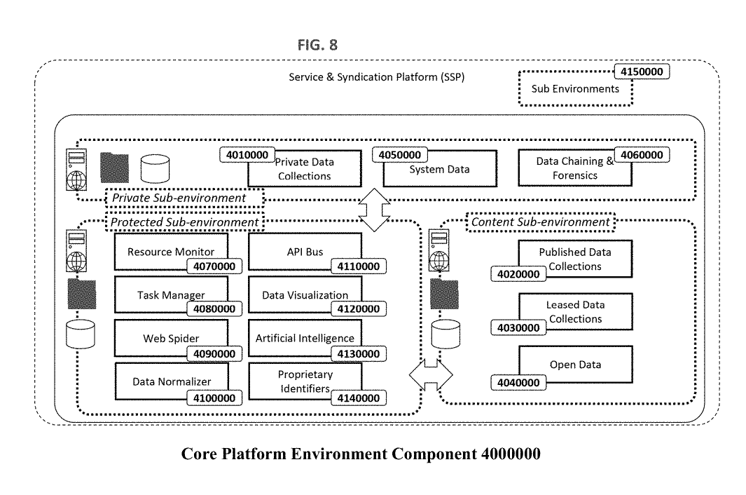

FIG. 8 exemplarily depicts Core Platform Environment Components 4000000. The Core Platform Environment Components 4000000 include:

Private Data Collections: These are data and associated systems that are retained by the platform owner and are not made available beyond the CPE's Private sub-environment except abstractly through interaction proxies by appropriate resources in the CPE's Protected sub-environment.

Published Data Collections: These are data and associated systems that are managed by the platform owner directly but are published for use by all Platform Subscribers. The terms governing scope of the publish and scope of consumption are defined by the platform owner, and the CPE ensures this data is only made available per those defined terms, but in general, once these terms are defined, all Platform Subscribers have access to the defined Published Data Collection(s) using those terms.

Leased Data Collections: These are data and associated systems that are managed by the platform owner, by another Platform Subscriber, or even by a 3^{rd} party. These data/systems are then leased to the platform owner and/or a/its Platform Subscriber(s). In this way, the concept of leasing is more complex than publishing, as there can be leases from a provider, and perhaps the platform owner can only publish aggregations of this data, or can only lease this data to specific Platform Subscribers in certain ways. In general, publishing is a subset of leasing, whereby the rules of consumption can be applied globally. Leasing is tailored to the situation.

Open Data: These are data and associated systems that are made available to the public. This includes information published on public websites and other publicly available sources. The platform owner acquires and absorbs many forms of Open Data; however, once Open Data has been acquired and/or absorbed and/or curated, the resulting data and data systems, individually and aggregated, become the intellectual property of the platform owner (a Private Data Collection, which can then become a Published or Leased Data Collection).

System Data: These data and associated systems represents user, role, configuration, cache, application management, lookup, and other data that defines, manages and is otherwise collected during the day-to-day operations conducted by the platform owner, its Platform Subscribers and/or their customers. It does not represent data in a collection per se, but rather data about the data, or data needed to use the data. As such, this data belongs to the platform owner the same as Private Data, to be used/shared per the platform owner's discretion and in concert with any applicable privacy policies or personally identifiable information policies, to fulfill the terms of Published and/or Leased Data Collections within the SSP.

Data Chaining & Forensics: This is a subset of System Data that deserves special attention. As data is acquired, absorbed and/or curated within the SSP, there becomes a complex mix of source and derived data that can travel cyclically from a 3^{rd} Party to the platform owner to one or more Platform Subscribers, and then back to the platform owner or the 3^{rd} Party. This cycle could be repeated n-number of times (where n is an integer) as data and services become further refined. The CPE tracks data as it journeys through this complex set of transformations. Each element of data that is output to a client's user interface can be traced backwards through its lifecycle in the SSP, which accomplishes two key things:

Management of the Data Chain: With the steps visible, it makes upholding the terms of any lease or publication more enforceable and unbiased in the event of a conflict.

Forensics: Knowing how various “authorities” arrive at any of their conclusions has been a challenge in the data arena for a long time. With CPE managed data, forensics can be done to validate authenticity down to the source of acquisition for any derived data collection. Forensics can also shed light on derived works relying on stale data that should be refreshed. Forensics also support more granular troubleshooting and data processing corrections. Similar to double-entry accounting when data is absorbed and/or curated within the SSP there is the resulting data record/item but there is also a record about how and when that particular data record/item was processed. In addition to that, the data record/item has a proprietary identifier associated with it that acts as a finger-print for that data upon absorption.

Authentication of the Data Chain: Rights are further managed using blockchain technology to ensure that data is indeed owned by the claimant of that data in the way they state they own it.

Resource Monitor: The CPE Resource Monitor can evaluate resources such as CPU, RAM, Disk I/O, Servicing Limits and other factors. Based on these evaluations the Resource Monitor can act independently or through a messaging mechanism to alter resource allocations across the CPE, adding processing, storage or other bandwidth as needed for the platform to function. In the even all resources are maximized, the Resource Manager can borrow from other less busy resources, or borrow from lower priority resources.

Task Manager: This component functions as a parallel processing enabled orchestrator, queuing system and routing engine across the CPE. It can interact with all other platform components as well as Foundation Software Systems. Tasks can be configured, scheduled and monitored via the Management Studio. The Task Manager will utilize the Resource Manager to throttle resources in real-time, and completes acquisition, absorption and curation tasks across platform Data Collections.

Web Spider: The Web Spider is similar to the Task Manager, but manages a specific set of web spidering/crawling tasks. For this reason, it can lean on the Resource Manager and in some cases, it has real-time high-bandwidth collection tasks that demand prioritized resources. Web Spider supports several types of web collection including spidering, crawling, and scripted crawling (e.g., filling out of forms and extracting results), and can act at the HTTP or socket level.

Data Normalizer: This component offers a set of data normalization tools (this like relational database theory) across the platform. Although many other technologies are used to generate these normalizations (e.g., natural language processing, ontological reasoning, machine learning and more), this component handles the more rudimentary types of processing that occur before and after the more advanced processing. Some examples include:

Data Conversion: Text to dates, text to numbers, converting to Boolean representations, etc.

Friendly Names: Managing data collection field names and their “Friendly Name” for use when rendered to an end user.

Lookup Tables: Managing lists which can be derived from structured data, or from unstructured data using various AI components, definitive lists of standardized terms.

Optical Character Recognition: Converting images (PDF, TIFF, PNG, etc.) to textual data for further curation

Translation Sets: Can be used for both localization (e.g., translating data from one language to another), and for normalization (e.g., translating several different data values to a standard value)

API Bus: This component combines a set of APIs which are managed by a light-weight service-bus. The Task Manager, Resource Manager and some of the Foundation Software System components flesh out the rest of what would be a traditional Enterprise Service Bus (ESB) without the overhead of a separate ESB. Different portions of the API are accessible to different components, but in general, with the right permissions, the whole of the SSP can be commanded and controlled via APIs in the API Bus service catalog.

Data Visualization: This component offers up different visualization capabilities. Much more than a typical charting tool, Data Visualization can serve up drillable/actionalble data in actionable 2D and 3D (VR/AR) formats.

Artificial Intelligence: This component serves up a number of libraries which can be accessed through the Task Manager and configured via the Management Studio to support natural language processing, associative graphing, machine learning, machine translation, and both semantic and owl reasoning/inference capability.

Proprietary Identifiers: This component tracks identifiers that are issued, managed and claimed as intellectual property by the platform owner. These identifiers are used with the Data Chaining & Forensics component, baking them into the data chain for rights management.

Sub Environments: Although not a component in and of themselves, CPE and the Platform Subscriber Environment (PSE) are segmented into sub environments based on the purpose of software, data and/or content placed in a particular sub environment. General categories are “Private”, “Protected” and “Content”:

Private: Resources in this environment are isolated to the maximum extent possible and can only be reached by resources in a protected environment.

Protected: Resources in this environment are also isolated to the maximum extent possible; however, they are reachable by content environments and act as a bastion between content environments and any updates that persist to a private environment (e.g. updates to a data chain)

Content: Content environments are similarly isolated to the maximum extent possible; however, are made available to Subscriber Platforms, to Turnkey Client systems, and therefore, can also be public facing.

Tier 1: Foundation Software Systems

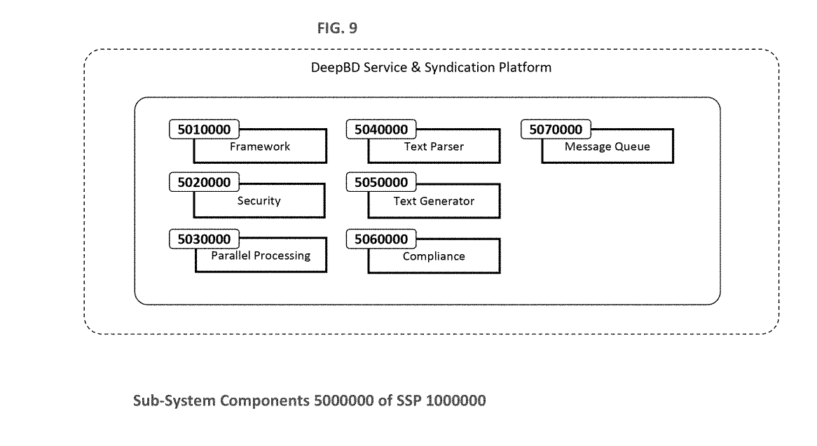

These components represent the core of the SSP—the software here is utilized across the entire platform to ensure each component is built using standardized architectural practices. FIG. 9 exemplarily depicts sub-system components 5000000 of SSP 1000000. As depicted in FIG. 9, the top-level components that make up the subsystem components include:

Framework: This set of foundational classes ties together all the components in the Foundational Software Systems and any components built on top of the Foundational Software Systems. Critical items such as logging, messaging and handling, along with façade access to commonly used items are part of this Framework along with interface-based approaches for applying framework approaches to a broad array of objects.

Security: This component contains the reusable subcomponents/classes needed to manage users, roles, AD/LDAP integration, IAM/3rd Party role/group integration and automation, port scrambling, temporary role escalation, audits, X.509 (e.g. SSL) certificates & authorities, and encryption.

Parallel Processing: There are several places within the SSP and beyond where parallel processing is an important capability. This component enables parallel processing while upholding other standard tenants of the Framework and Security components.

Text Parser: This component is a rules-based text parser that enables for straight text, RegEx, HTML, JSON, YAML/TOML, XML and other parsing abilities. It is not only used for stream or file processing, but also as a tool through which AI components can create/modify how data is being processed during various curation tasks in the Task Manager.

Text Generator: This component is a rules-based text generator which can be used to build templated emails, reports, static web pages and other textual output merged with data.

Compliance: This component standardizes various compliance requirements across the software and includes libraries for vulnerability scans, section 508 review, enforcing various levels of auditing and other standards.

Message Queue: Queuing is a common capability across the SSP, and this component offers a standardized approach to queues, queue management, message formats, and allows for customizing of message formats.

### IMPLEMENTATION

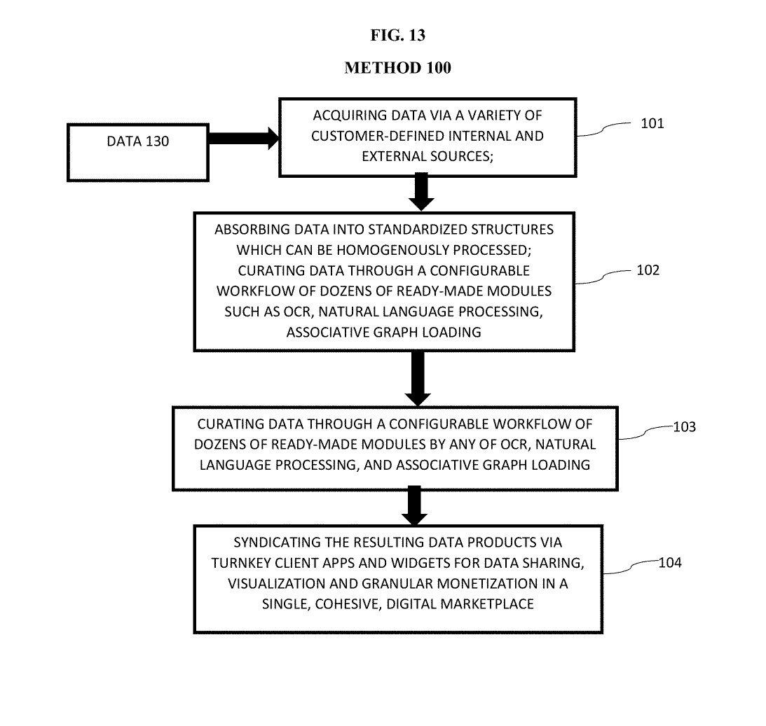

As exemplarily depicted in FIG. 13, the method 100 includes various steps for acquiring, absorbing, and curating data. For example, in step 101, data is acquired via a variety of customer-defined internal and external sources, in step 102, data is absorbed into standardized structures which are homogenously processed, in step 103, data is curated through a configurable workflow of ready-made modules, and in step 104, the resulting data products are syndicated via turnkey client apps and widgets for data sharing, and a visualization and a granular monetization in a single, cohesive, digital marketplace.

Having described all the high-level components of the SSP above, below will describe an exemplary implementation of real-life applications of the subsystems and components to describe how these components interact in a way that significantly improves upon the state of the art. This will exemplarily be accomplished via a description of several embodiments: Provision a Platform Subscriber Environment, having that subscriber create a Data Collection, and then Provision a Turnkey Client to enable their data to be shared with their customers.

### Provision a Platform Subscriber Environment

In one exemplary embodiment, a company will request to use the SSP to make their company's data available to customers in a new way. This company is, for example, a research firm with electronic files and paper files, both of which contain data of value but are not currently (easily) aggregated in such a way that the company can monetize the data.

The company signs up for a subscription on the platformer owner's website (i.e., a medium which holds the invention as described herein), and for the purpose of this embodiment, they select a subscription package which requires no customization. During the purchasing process, they are asked to invite users to use the platform and they can define if the users are administrators or not.

The e-commerce integration exists within the Turnkey Client 2120000, which handles processing credit cards and setting up the subscription and licensing. Once this is stored, and the payment comes back as approved from the merchant account gateway, the person paying for the license along with the people they are inviting are all created via calls to the API Bus 4110000, and calls to that same component are used to trigger a provisioning event to Environment Provisioning 1100000 which runs through the process outlined in FIG. 3 to create the environment for the Platform Subscriber and send appropriate emails to all the users so they can login and access their PSE from the Management Studio 2000000.

### Create a Data Collection

Users access the Management Studio 2000000 via a web browser on a desktop or mobile device, and if they are an administrator, they will be able to use the Manage Data Collections 2060000 component to create a data collection. In this use case, even though they have both paper and electronic documents, they will create only one data collection for their electronic documents.

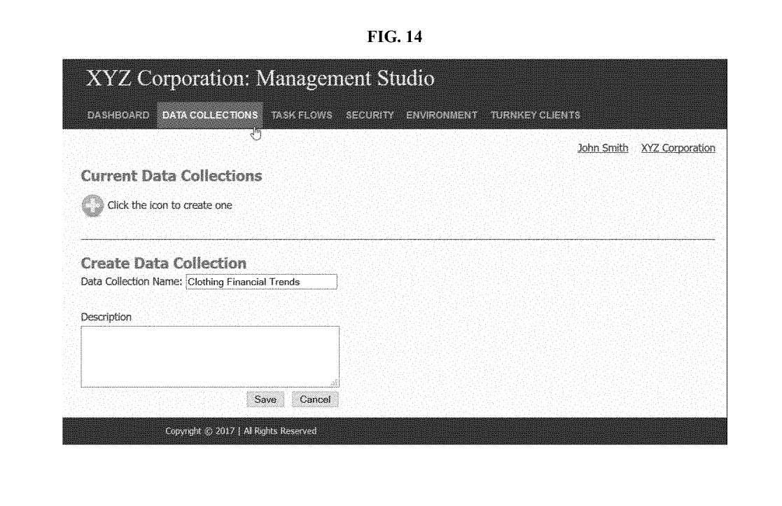

Manage Data Collections 2060000 allows the user to store a name and description to keep things human readable (i.e., natural language text), so they call it “Clothing Financial Trends” and type a description about how the data collection contains the last 15 years of financial trend data for sales of goods in the clothing industry (e.g., as exemplarily depicted in the Graphical User Interface of FIG. 14). Note that this could be almost any kind of data: medical records, aviation instrument data streams, case law, newspaper articles, shopping metrics, recipes, seismic studies, museum catalogs, etc. The SSP can acquire, absorb and curate a wide variety of data sources and is indifferent toward the subject matter of the target data.

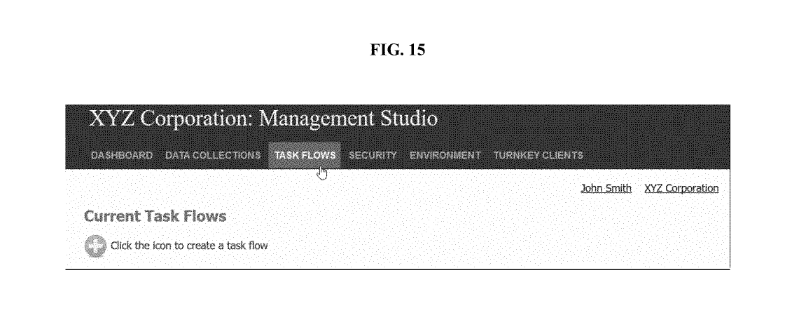

For this data collection, the user then needs to setup one or more tasks to do something with the data, which is done via the Manage Tasks 2070000 component (e.g., as exemplarily depicted in the GUI of FIG. 15). This component allows a user to define TaskFlows which are further composed of SubTasks to accomplish acquisition, absorption and curation of their Data Collections.

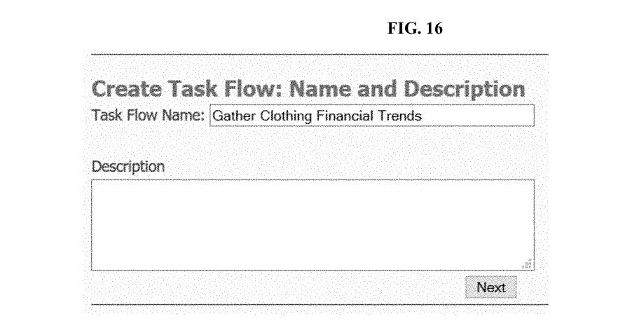

The Manage Tasks 2070000 component provides the user an interview-style interface (e.g., as depicted in the GUI of FIGS. 16-20) which guides them through the steps of setting up a Task Flow. In this example they are interviewed (i.e., a back and forth dialogue between user and system) first to acquire the data, and the user selects that their data is on a shared server folder on their local network. The interview presents options relevant to the next steps, such as if they want the files acquired to the PSE or left local, if the files are to be removed after being acquired or left alone, etc. In this example the user requests the SSP to acquire a copy of the file and store it within the PSE and then delete the file from the local share. It is noted that the SSP supports acquisition from a variety of sources, be they local files, S3 buckets on Amazon™, ftp/http file transfers, web scraping/crawling, links to relational and/or NoSql databases, API calls or even socket-level streaming. Each form of acquisition comes with an interview to guide the user and some forms of acquisition are more complex than others (for example, a web scrape might mean scripting some automation to fill in a form and retrieve specific results).

The interview as shown in FIGS. 16-20 will continue to absorption, where the user can specify any steps needed to standardize their data, although the SSP does this automatically where possible. For example, some of their electronic files are PDF format and need to be run through Optical Character Recognition (OCR) to have text extracted, or in one embodiment they will be scanning their paper files and saving the scans as TIFF images, also requiring OCR. The file processing in the Task Manager 4080000 (as discussed in more detail below) detects if a file contains searchable/text content, and if it does then no OCR is applied. However, if the file appears to be an image or a non-searchable PDF, the system runs it through OCR as part of the absorption process. In addition, another absorption step is to run files through a process known as “entity extraction”, which is embodied in the Artificial Intelligence 4130000 component, and is made available as a service, again, through the Task Manager 4080000 component, and extracts people's names, locations and organizations using standard NLP Classifier libraries. In this exemplarily embodiment, the user accepts these defaults, although the user could elect to customize these absorption options.

At this point, the user could continue adding curation tasks to the Task Flow, but in this exemplary embodiment, since they are new, they just want to see what the platform can illuminate without further curation. They schedule the task to check the folder every 5 minutes, and save this Task How.

Now the user, outside of the SSP can get data into the system by either copying and pasting files from elsewhere in their company to the target folder, or by scanning paper files into an electronic format and saving those files in the target folder, which will be checked every 5 minutes and processed according the Task Flow they have configured.

In the background, the Manage Tasks 2070000 communicates via the API Bus 4110000 to setup the Task Flow in the Task Manager 4080000 component, which will monitor the folder and use the Message Queue 5070000 to acquire the files to S3 from the target share, and then ensure each queued item goes through the OCR and NLP Sub Tasks defined in the Task Flow. The results of NLP will generate a repository of keywords (Also known as metatags) found in the file data and map those to the files in which they were found. The data about the tasks and configuration are examples of PSE System Data 3050000, whereas files that have been acquired and absorbed will be stored as a Private Data Collection 3010000 until the user decides on any elements they which to publish (if any), lease (if any) or release as open data (if any).

Also, in the background, the Task Manager 4080000 will issue Proprietary Identifiers 4140000 for each file (to start with), signing those identifiers with an X.509 Cert generated for the PSE using the Security 5020000 component, and then registering each file as part of the CPE's Data Chaining and Forensics 4060000 component, which will register the cert and a hash of the content with a block chain, so that this content if discovered anywhere else on the SSP can be flagged as a potential data licensing issue.

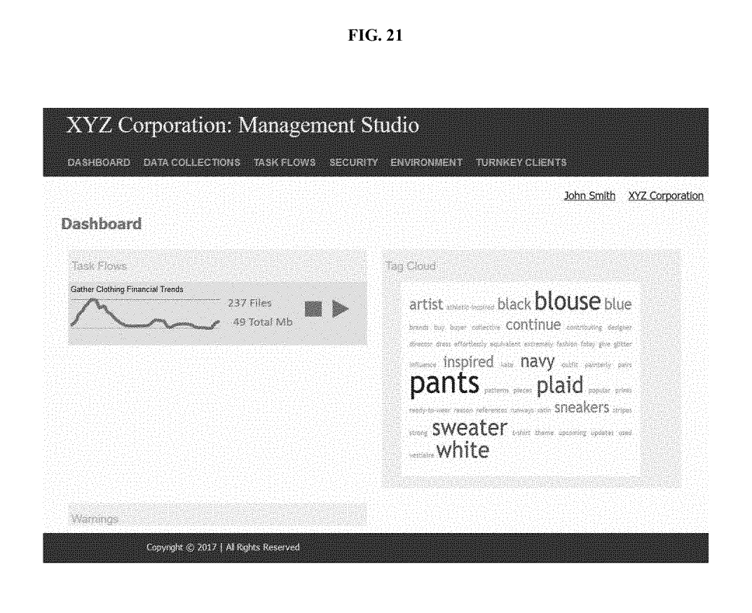

Because the SSP is a cohesive platform, this activity can be monitored via the Management Studio 2000000 on the System Dashboard 2050000 which by default shows a list of Task Flows and their status, along with any warnings or errors reported (which are generated via the Framework 5010000 component), they can user the Environment Manager 2120000 component to see the actual virtual environment and drill-down statistics of the servers/services in play fulfilling the processing requirements (e.g., as depicted in FIG. 21).

Furthermore, because the platform can self-scale to meet demand, the Task Manager 408000 will use data from the Message Queue 5070000 and the Resource Monitor 4070000 to evaluate the number of items on the queue against CPU, RAM, Disk I/O usage for the various Sub Tasks in play. Resources are scaled up and down to meet demand and metrics are gathered over the course of time to improve accuracy of this scaling ability. The Task Manager can then spawn additional threads for processing using the Parallel Processing 5030000 component, or it can launch entirely new instances of servers using the Update Environment 1100001 (FIG. 4) component. Resources can be shut down and removed using the same components. For example, if the folder is sitting empty, then the PSE will use minimal resources; however, if 100 GB of files are dropped into the target folder, the Task Manager 4080000 will begin queuing up files to be acquired in the Message Queue 5070000. The number of items in the queue will grow quickly, and in response to the size of the queue, the Task Manager will spawn additional threads (up to 2 per CPU core, by default although this can be configured).

At this point, if the CPUs are all engaged, then that will signal the Task Manager to spin up another server to handle the growing Message Queue (and if there are many small files, it Task Manager might spawn several new servers each with parallel processing threads). At some point, files being transferred to S3 will need to go through OCR processing. The same approach occurs, only the load will be balanced across files being uploaded to S3 and files needing to go through OCR. Lastly, files pass through NLP, and system resources will be balanced across all requested processing in play.

### Provision a Turnkey Client

In this example, the user has moved over their files to the target shared folder, and the files have been acquired and absorbed using OCR and NLP capabilities integrated within the platform, as demonstrated in the previous section. Now the Platform Subscriber has options. In one embodiment, the user could publish their data for syndication across the SSP, in which case they would use the Management Studio 2000000's Manage Data Collections 2060000 to make this data collection available to other PSEs at a market rate (set by the system, and editable within a range, by each PSE).

However, the Platform Subscriber could also provision a Turnkey Client 2120000 to make data available to prospective customers. The Turnkey Client component offers an array of solutions. In one exemplary embodiment in which the customer selected the most full-featured solution, which consists of an MVC GUI which allows customers to sign-up using a credit card, the customer can access the system, run searches using a tag cloud and be notified via email when tags of interest are spotted in the data.

When the Platform Subscriber selects this option, the Turnkey Client 2120000 component guides them through an interview process which collects private label information, allows for selection of a theme, configuration of a domain binding, asks for merchant account information (or directs them to a merchant account provider, if needed) and then uses this information to provision a website (generated via the Update Environment 1100001 (FIG. 4) component). The website supports role-base authentication using the same domain security used by the Management Studio, and in fact the subscription processing is also the same, just geared toward the Turnkey Client website, and logins are isolated to the PSE's provided systems.

Customers of the Platform Subscriber complete sign-up using the same e-commerce pipeline described earlier in the use cases, customized to the brand and set-up of the selected Turnkey Client, and instead of email with links to the Management Studio, they receive a link to the specific Turnkey Client. The default Turnkey Client is made up of several web pages: A Kanban style view with cards based on the data collection items (in this case pointers to files on S3), a search page to do adhoc tag cloud and free text searches, sub pages to save searches to be executed at interval and send email alerts, a page for user profile management (avatar, password, etc).

As described in the above exemplary embodiments, the SSP gives Platform Subscribers a one-stop shop to monetize their data which was previously buried on hard drives or in filing cabinets within their organization, conducting sophisticated acquisition, absorption, curation, syndication and monetization with little to no technical knowledge. Yet the system is robust enough, with a little more technical knowledge, completely custom Task Flows with complex curation steps can be developed, deployed and syndicated.

The SSP does what nothing else in the market place currently offers. From the filing cabinet to a commerce-enabled GUI, with democratized cutting-edge data processing technology allowing the platform owner and their subscribers to syndicate a wide area of data products all with a forensic trail to manage digital data rights.

### Exemplary Hardware Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

FIG. 10 depicts a an example of a computing node in accordance with the present invention. Although computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer server 12 is only one example of a suitable computing node and is not intended to suggest any limitation as to the scope of use or functionality of embodiments of the invention described herein. Regardless, computer server 12 is capable of being implemented and/or performing any of the functionality set forth herein.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in cloud computing environments (see e.g., FIG. 3) where tasks are performed by remote processing circuits that are linked through a communications network. In a distributed cloud computing environment, program modules may be located in both local and remote computer system storage media including memory storage circuits.

Referring again to FIG. 10, computer system/server 12 is shown in the form of a general-purpose computing circuit. The components of computer system/server 12 may include, but are not limited to, one or more processors or processing units 16, a system memory 28, and a bus 18 that operably couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. In some embodiments, program modules 42 generally carry out the functions and/or methodologies of embodiments of the invention as described herein.

Computer system/server 12 may also communicate with one or more external devices 14 such as a keyboard, a pointing circuit, a display 24, a camera, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

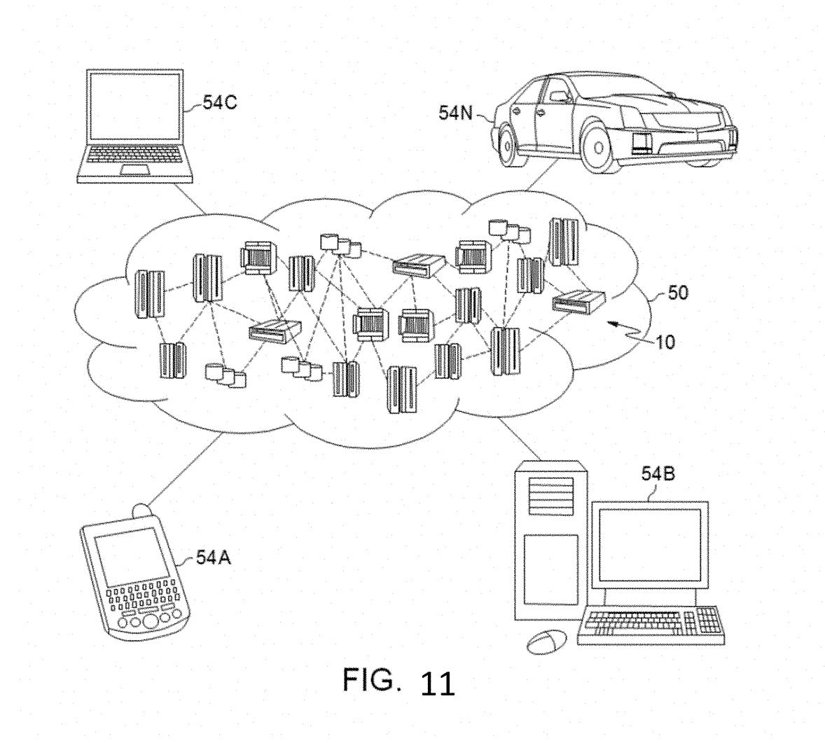

Referring now to FIG. 11, illustrative cloud computing environment 50 is depicted. As shown, cloud computing environment 50 comprises one or more cloud computing nodes 10 (e.g., computer system 12 (FIG. 10) with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 10 are intended to be illustrative only and that computing nodes 10 and cloud computing environment 50 can communicate with any type of computerized circuit over any type of network and/or network addressable connection (e.g., using a web browser).

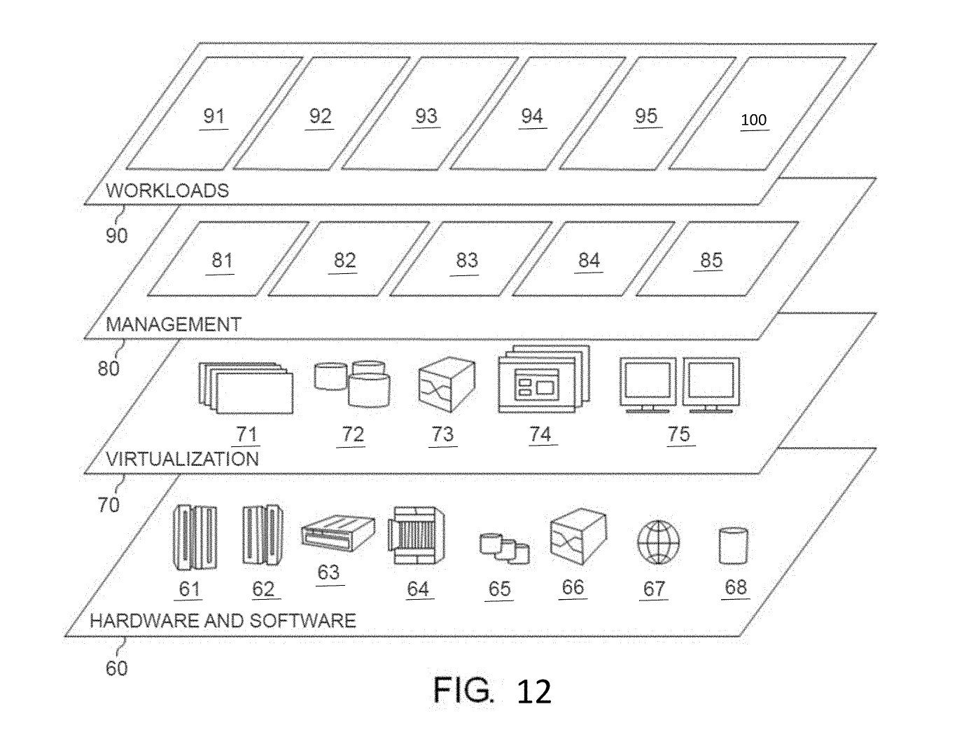

Referring now to FIG. 12, a set of functional abstraction layers provided by cloud computing environment 50 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the baggage screening method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

1. A computer implemented data processing method, the method including:
acquiring data via customer-defined internal and external sources;
absorbing data into standardized structures which can be homogenously processed;
curating data through a configurable workflow of a plurality of ready-made modules including any of optical character recognition (OCR), Natural Language Processing (NLP), and Associative graph loading; and
syndicating the resulting data products via turnkey client apps and widgets for data sharing, visualization and granular monetization in a single, cohesive, digital marketplace.

2. The computer-implemented method of claim 1, wherein the acquiring acquires the data based on a subscription package.

3. The computer-implemented method of claim 1, wherein the customer-defined internal and external sources further define limitations on a type of access to the data by a user during the acquiring.

4. The computer-implemented method of claim 1, wherein a user sets up one or more tasks for the data by setting up a task flow including sub-tasks to manage how the acquiring, absorbing, and curating the data perform their processes.

5. The computer-implemented method of claim 4, wherein an interview-style interface guides the user through the setting up of the task flow.

6. The computer-implemented method of claim 5, wherein the interview-style interface includes:
a back and forth dialogue between user and the interview-style interface to acquire the data, and the user selects that the data is on a shared server folder on a local network; and
a back and forth dialogue between user and the interview-style interface to set limitations on an access to the data.

7. The computer-implemented method of claim 1, wherein the acquiring includes an interview-style interface that guides the user through the acquiring with each type of acquisition coming with an interview to guide the user.

8. The computer-implemented method of claim 4, wherein an interview-style interface:
guides the user through the setting up of the task flow; and
guides the user through the absorbing by requesting the user specify any steps required to standardize the data for the workflow.

9. The computer-implemented method of claim 4, wherein an interview-style interface for setting up the task flow includes an option for setting a folder on a local drive of the user to automatically upload via the absorbing without requiring the user to login to the interview-style interface, and
wherein the absorbing scans the local drive at a set interval of time to update the data.

10. The computer-implemented method of claim 9, wherein the absorbed data from the local drive is saved in a private folder that is not accessible via the turnkey client apps and widgets until the user approves the data for the turnkey client apps and widgets.

11. The computer-implemented method of claim 10, wherein the user sets a type of access when opening the data from the private folder to be accessible as leased data, published data, or open data.

12. The computer-implemented method of claim 1, wherein internal proprietary identifiers are issued for each file of the data that is absorbed which includes registering a certification with the data and a hash of content with a block chain, so that the content is flagged as a potential data licensing issue if discovered on a turnkey client apps and widgets not associated with that particular client.

13. The computer-implemented method of claim 1, wherein internal proprietary identifiers are issued for each file of the data so that the content is flagged as a potential data licensing issue if discovered on a turnkey client apps and widgets not associated with that particular client.

14. The computer-implemented method of claim 10, wherein internal proprietary identifiers are issued for each file of the data that is absorbed which includes registering a certification with the data and a hash of content with a block chain, so that the content is flagged as a potential data licensing issue if discovered on a turnkey client apps and widgets not associated with that particular client.

15. The computer-implemented method of claim 1, wherein the turnkey client apps and widgets are managed on by the configurable workflow of a plurality of ready-made modules on a separate platform from the user such that the separate platform self-scales to meet demand of multiple users using the turnkey client apps and widgets.

16. The computer-implemented method of claim 15, wherein resources are scaled up and down to meet demand and metrics and are gathered over the course of time to improve accuracy of the scaling by the separate platform.

17. The computer-implemented method of claim 15, wherein the demand is met by one of:
spawning additional threads for processing using the a parallel processing component;
launching new instances of servers using an update environment component.

18. The computer-implemented method of claim 1, wherein a user, via the turnkey client apps and widgets and a subscription thereto, accesses the data, runs searches using a tag cloud, and is notified when tags of interest are spotted in the data.

19. A computer program product for data processing, the computer program product comprising a computer-readable storage medium having program instructions embodied therewith, the program instructions executable by a computer to cause the computer to perform:
acquiring data of customer-defined internal and external sources;
absorbing data into standardized structures which can be homogenously processed; curating data through a configurable workflow of a plurality of ready-made modules including any of optical character recognition (OCR), Natural Language Processing (NLP), and Associative graph loading; and
syndicating the resulting data products via turnkey client apps and widgets for data sharing, visualization and granular monetization in a single, cohesive, digital marketplace.

20. A data processing system, the system comprising:
a processor; and
a memory operably coupled to the processor, the memory storing instructions to cause the processor to perform:
acquiring data via customer-defined internal and external sources;
absorbing data into standardized structures which can be homogenously processed; curating data through a configurable workflow of a plurality of ready-made modules including any of optical character recognition (OCR), Natural Language Processing (NLP), and Associative graph loading; and
syndicating the resulting data products via turnkey client apps and widgets for data sharing, visualization and granular monetization in a single, cohesive, digital marketplace.
